(19) United States
(12) Patent Application Publication
(10) Pub. No.: US 2024/0169281 A1
(43) Pub. Date: May 23, 2024

(54) SHOP MANAGEMENT SERVER, RECORDING MEDIUM, ANDSHOP MANAGEMENT METHOD

(71) Applicant: NEC Platforms, Ltd., Kawasaki-shi (JP)

(72) Inventor: Hiroyuki TAKANE, Kanagawa (JP)

(73) Assignee: NEC Platforms, Ltd., Kawasaki-shi (JP)

(21) Appl. No.: 18/386,285

(22) Filed: Nov. 2, 2023

(30) Foreign Application Priority Data
Nov. 18, 2022 (JP) 2022-184581

(51) Int. Cl. G06Q 10/0631; G06Q 30/015

(52) U.S. Cl. CPC G06Q 10/06311; G06Q 30/015

(57) ABSTRACT

A shop management server according to the present invention includes: a memory; and at least one processor coupled to the memory. The processor performs operations. The operations include: acquiring, at a shop in which a customer consumes a product, an image of the shop that is an image showing at least one of an area for providing the product to the customer and an area in which the customer consumes the product; determining a type of an instruction to a customer service clerk who provides the product to the customer by applying the image of the shop to a determination model for determining the instruction; acquiring the instruction corresponding to the determined type of the instruction; and outputting the acquired instruction to the customer service clerk.

This application is based upon and claims the benefit of priority from Japanese Patent Application No. 2022-184581, filed on Nov. 18, 2022, the disclosure of which is incorporated herein in its entirety by reference.

### TECHNICAL FIELD

The present invention relates to processing of shop information, and particularly to processing of information related to shop clerks.

### BACKGROUND ART

Examples of processing of information regarding a shop are described in JP 2019-192056 A, JP 2015-210601 A, and JP 2003-044954 A. JP 2019-192056 A discloses a restaurant system that manages contents of services provided to members. JP 2015-210601 A discloses a server that outputs a notification to a customer terminal operated by a customer based on information from the customer terminal of the customer. JP 2003-044954 A discloses a heinous crime prevention system that detects a change in a video image to detect a heinous criminal.

### SUMMARY

An object of the present invention is to provide a shop management server or the like that increases efficiency of work of customer service clerks.

A shop management server according to an example aspect of the invention includes: a memory; and at least one processor coupled to the memory. The processor performs operations. The operations include: acquiring, at a shop in which a customer consumes a product, an image of the shop that is an image showing at least one of an area for providing the product to the customer and an area in which the customer consumes the product; determining a type of an instruction to a customer service clerk who provides the product to the customer by applying the image of the shop to a determination model that determines the instruction; acquiring an instruction corresponding to the determined type of the instruction; and outputting the acquired instruction to the customer service clerk.

A non-transitory, computer-readable recording medium according to an example aspect of the invention records a program for causing a computer to execute: acquiring, at a shop in which a customer consumes a product, an image of the shop that is an image showing at least one of an area for providing the product to the customer and an area in which the customer consumes the product; determining a type of an instruction to a customer service clerk who provides the product to the customer by applying the image of the shop to a determination model for determining the instruction; acquiring the instruction corresponding to the determined type of the instruction; and outputting the acquired instruction to the customer service clerk.

A shop management method according to an example aspect of the invention includes: acquiring, at a shop in which a customer consumes a product, an image of the shop that is an image showing at least one of an area for providing the product to the customer and an area in which the customer consumes the product; determining a type of an instruction to a customer service clerk who provides the product to the customer by applying the image of the shop to a determination model for determining the instruction; acquiring the instruction corresponding to the determined type of the instruction; and outputting the acquired instruction to the customer service clerk.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a shop management server;

FIG. 2 is a flowchart illustrating an example of operations of the shop management server;

FIG. 3 is a block diagram illustrating an example of another configuration of the shop management server; and

FIG. 4 is a block diagram illustrating an example of a hardware configuration of the shop management server.

### EXAMPLE EMBODIMENT

Example embodiments of the present invention will be described with reference to the drawings. However, the example embodiments are not limited to the description in the drawings.

In each example embodiment, a shop management server processes instructions for customer service clerks to work for providing products at an eating place such as a restaurant or a coffee shop where customers receive the products from the customer service clerks and consume the products. Customer service clerks are clerks who serve customers in order to provide products to the customers at a restaurant where the customers consume the products, in an area for providing the products to the customers, such as a serving space, and in an area where the customer consumes the product, such as a dining space.

In the following description of each example embodiment, as an example of customer service clerks, customer service clerks serving customers in a dining space of a restaurant will be taken. In the following description, it is assumed that a plurality of customer service clerks work at the restaurant. The number of customer service clerks may be fixed or changed. The number of customer service clerks may be changed to one or zero due to temporary movement or the like. However, in each example embodiment, an instruction for one customer service clerk may be processed.

The customer service clerks may accompany the customers after payment not only in the dining space but also to the entrance at the restaurant. Furthermore, the customer service clerks may accompany the customers to the outside of the restaurant building such as to the parking lot as courtesy toward the customers. Therefore, the restaurant is not limited to an area in which products are directly provided, and may include an area used by the customer service clerks to treat customers, such as the entrance and the parking lot.

### FIRST EXAMPLE EMBODIMENT

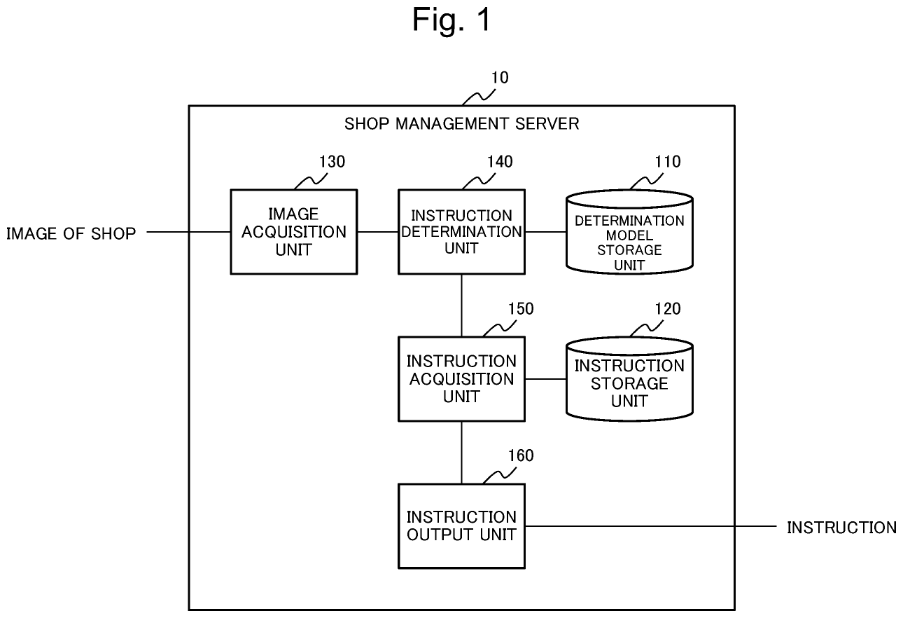

FIG. 1 is a block diagram illustrating an example of a configuration of a shop management server 10. The shop management server 10 includes a determination model storage unit 110, an instruction storage unit 120, an image acquisition unit 130, an instruction determination unit 140, an instruction acquisition unit 150, and an instruction output unit 160.

The determination model storage unit 110 stores a determination model for determining an instruction. Specifically, the determination model storage unit 110 stores a determination model for determining the necessity of an instruction to a customer service clerk at a shop or the type of an instruction required by the customer service clerk, based on an image of the shop that is an image of the shop where customers consume products. For example, the determination model storage unit 110 may store a determination model for determining the necessity of an instruction, in accordance with each type of instruction described next, such as the customer service clerk' work such as serving. Alternatively, the determination model storage unit 110 may store a determination model for determining the type of instruction that needs to be output to the customer service clerk. The determination model storage unit 110 stores a determination model that has learned using artificial intelligence (AI), for example, a machine learning technique. For example, when determining whether an instruction to serve a dish is necessary, the determination model storage unit 110 stores a determination model that has learned by using teacher data including an image of the serving space and the result of a determination on whether the serving instruction is necessary. If the area includes a plurality of areas such as a dining area, a waiting room, an entrance, and a parking lot, the determination model storage unit 110 may store a determination model related to each area.

The instruction storage unit 120 stores instructions to customer service clerks at the shop who provide products to customers. The instructions indicate the contents of work to be executed by the customer service clerks to provide products to the customers. The instructions may be classified based on the contents of work or the position where the work is to be executed. Hereinafter, the classification of instruction will be called “type of instruction”. Products such as dishes provided may be different among restaurants. Therefore, at each shop, the shop manager or the like may determine the contents of instructions and the types of instructions for the customer service clerks at the shop. For example, an administrator such as a shop manager may determine as appropriate the types of instruction and the contents of instructions in accordance with the size and type of the shop, the products to be handled, the customer service clerks, and the like. In this case, the instruction storage unit 120 stores the types of instructions and the contents of instructions in association with each other. The types of instructions include serving and removing dishes, replenishment of drinking water, support of the customer service clerks, guidance of customers, accounting, work at a place outside the building such as a parking lot, and work at the occurrence of a sudden or exceptional event such as a fire, for example. The types of instruction information stored in the instruction storage unit 120 are arbitrary. The types of instruction information may be voice information, text information, or image information, for example.

The image acquisition unit 130 acquires an image of a shop. The image of a shop is an image of a shop where customers consume products, which shows at least one of an area such as a serving space for providing the products to the customers and an area such as a dining area in which the customers consume the products. For example, the image acquisition unit 130 acquires, as the image of the shop, images of the serving area and the dining space in the shop from cameras installed in the shop. The image of the shop is not limited to the images of the serving area and the dining space, and may include at least one of an image of each table, an image of the accounting area, an image of the waiting room, an image of the entrance, and an image of the parking lot. The image of the shops may be a moving image or a set of still images such as time-lapse images. If the shop contains a plurality of areas, the image acquisition unit 130 may acquire the images of the plurality of areas as the image of the shops. In this case, the image of each area may be an image different in specification among the areas.

The instruction determination unit 140 applies the image of the shop to a determination model for determining an instruction, and determines the type of instruction to a customer service clerk who provides a product to a customer. For example, if the determination model storage unit 110 stores a plurality of determination models for determining the necessity of an instruction related to each work, the instruction determination unit 140 applies the image of the shop to the plurality of determination models to determine the necessity of an instruction for each work. If there is any work that requires an instruction, the instruction determination unit 140 may output the type of instruction related to the work that requires an instruction. For example, when serving is required, the instruction determination unit 140 operates as described below. The instruction determination unit 140 applies the image of the shop to the determination model for determining the necessity of the serving instruction, thereby to determine the necessity of the serving instruction. If the serving instruction is required, the instruction determination unit 140 outputs serving as the type of instruction. In this manner, the instruction determination unit 140 uses the determination model related to the type of instruction to determine whether the instruction of the type is necessary, and outputs the type of instruction when the instruction is necessary. Alternatively, if the determination model storage unit 110 stores a determination model for determining the type of a necessary instruction among instructions for a plurality of works, the instruction determination unit 140 may apply the image of the shop to the determination model to determine the type of instruction to the customer service clerk. If the determination model storage unit 110 stores a determination model related to each of the plurality of areas and the image acquisition unit 130 acquires an image of each of the areas, the instruction determination unit 140 may determine the type of instruction to the customer service clerk in each of the areas.

The instruction acquisition unit 150 acquires an instruction corresponding to the type of instruction determined by the instruction determination unit 140, from among the instructions stored in the instruction storage unit 120. For example, when it is necessary to serve a dish, the instruction acquisition unit 150 acquires a serving instruction a dish from among the instructions stored in the instruction storage unit 120. If the instruction determination unit 140 determines the necessity of an instruction related to each of the areas, the instruction acquisition unit 150 may acquire an instruction to a customer service clerk in each of the areas.

The instruction output unit 160 outputs the instruction acquired by the instruction acquisition unit 150 to the customer service clerk. For example, the instruction output unit 160 may output an instruction to the customer service clerk via a wireless line. More specifically, if the instruction storage unit 120 stores voice information, for example, the instruction output unit 160 may output a voice instruction to a headphone such as a headset or an earphone worn by the customer service clerk via a wireless line. If the instruction acquisition unit 150 acquires an instruction related to each area, the instruction output unit 160 may output the instruction to a customer service clerk in the area. The instruction output unit 160 may store the output instruction together with the output time as history information.

### DESCRIPTION OF OPERATIONS

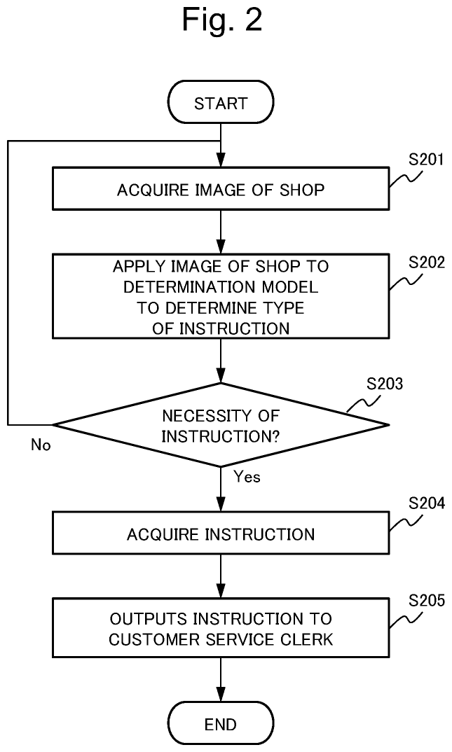

FIG. 2 is a flowchart illustrating an example of operations of the shop management server 10. The determination model storage unit 110 has stored a determination model. The instruction storage unit 120 also stores the instructions to a customer service clerk. The image acquisition unit 130 acquires an image of a shop (step S201). For example, in the case of a restaurant, the image acquisition unit 130 acquires an image of a dining space where the customer service clerk works as an image of the shop from a camera in the shop. The instruction determination unit 140 applies the image of the shop to the determination model to determine the type of instruction to the customer service clerk (step S202). When the instruction is unnecessary (No in step S203), the shop management server 10 returns to step S201. For example, if the instruction determination unit 140 determines that all the instructions are unnecessary using the determination model for determining the necessity of instructions, the shop management server 10 determines that no instruction is necessary. Alternatively, if the instruction determination unit 140 determines that there is no type of necessary instruction using a determination model for determining the type of necessary instruction, the shop management server 10 determines that no instruction is necessary. If the instruction is necessary (Yes in step S203), the instruction acquisition unit 150 acquires the instruction corresponding to the determined type of instruction from the instruction storage unit 120 (step S204). The instruction output unit 160 then outputs the instruction acquired by the instruction acquisition unit 150 to the customer service clerk (step S205). For example, the instruction output unit 160 outputs a voice instruction to a headset worn on the head of the customer service clerk.

Next, as a detailed example of the operations of the first example embodiment, an operation indicated by each instruction type will be described. In the following description of the operations, the shop management server 10 acquires an image of the shop from a camera installed in a shop or the like. The image of the shop is not limited to an image of the entire area of the shop, and may be an image of an area necessary for operations. The shop management server 10 outputs, as the instruction, a voice instruction to the headset of the customer service clerk via wireless communication. Therefore, the instruction storage unit 120 stores voice information as the instruction. In the following description, the shop management server 10 uses a wireless local area network (LAN) as an example of wireless communication network. Since the shop management server 10 uses a determination model described below for determination, the shop management server 10 may store layout information in the shop. The layout information is information indicating the positions of tables and passages in the dining area or parking positions in the parking lot, for example. If the layout of the shop is changed, the administrator or the like may update the layout information as appropriate.

(1) Serving of Dishes

Operations of the shop management server 10 when dishes are served in a restaurant will be described. In the following description, a place for serving dishes will be called “serving space”. It is assumed that order slips are placed in the serving space. That is, the shop management server 10 uses, as the image of the shop, the image of the serving space including the dishes for serving and the order slips. For brevity of description, it is assumed that the order slips are placed in order in which the orders were received. It is also assumed that the dishes for serving are completed in order in which the orders were received.

The instruction determination unit 140 uses a determination model for determining the necessity of a serving instruction. Hereinafter, this determination model will be called “serving determination model”. For example, the instruction determination unit 140 executes a determination as described below. The instruction determination unit 140 applies the image of an order slip to the serving determination model to determine the dish described in the order slip. For example, the instruction determination unit 140 determines the dish described in the order slip by using a serving determination model that executes character recognition. If there are a plurality of order slips, the instruction determination unit 140 determines the dish described in the order slip of the earliest order, for example. The instruction determination unit 140 further determines the dish placed in the serving space by using a serving determination model that executes image recognition. Then, instruction determination unit 140 determines the necessity of a serving instruction based on the dish described in the order slip and the dish placed in the serving space. For example, if it is determined that the dishes for serving are completed, such as if it is determined that all the dishes in the order slip are placed in the serving space, the instruction determination unit 140 determines that the serving instruction is necessary. The instruction determination unit 140 determines the type of serving instruction as the type of the necessary instruction. On the other hand, if it is determined that at least some of the dishes described in the order slip is not placed, the instruction determination unit 140 determines that the serving instruction is unnecessary. The person in charge of cooking may mistake the ordered dish due to misreading of the order slip or the like. Therefore, if the instruction determination unit 140 determines a dish that is not described in the order slip, the instruction determination unit 140 may determine whether another instruction is necessary, for example, whether an alert is necessary for the manager or the like in the kitchen. In this case, the shop management server 10 may output an alert to the manager or the like. The above description is based on the assumption that the dishes are completed in the order of the order slips. However, the instruction determination unit 140 may determine the necessity of the serving instruction for each of the plurality of order slips, not for the order of the order slips.

Next, operations of the shop management server 10 will be described. The image acquisition unit 130 acquires an image of the serving space. The instruction determination unit 140 applies the image of the serving space to the serving determination model to determine whether the serving instruction for the customer service clerk is necessary. If the instruction is unnecessary, the shop management server returns to the image acquisition operation by the image acquisition unit 130. If the instruction is necessary, the instruction determination unit 140 determines the type of the serving instruction as the type of the necessary instruction. The instruction acquisition unit 150 acquires the serving instruction stored in instruction storage unit 120. The instruction output unit 160 then outputs the serving instruction to the headset of the customer service clerk. The instruction in this case is an instruction such as “Serve the dish in order slip A”, for example.

In this manner, when the dish for serving is completed, the shop management server 10 outputs the serving instruction to the customer service clerk. Therefore, the customer service clerk does not need to confirm the completion of the dish for serving. That is, the shop management server 10 reduces the burden on the customer service clerk in the serving work, and achieves improvement in work efficiency. Furthermore, since the shop management server 10 determines the completion of the dish for serving, the person in charge of cooking does not need to determine the completion of the dish related to the order slip. Therefore, the shop management server 10 also reduces the work burden on the person in charge of cooking. The shop management server 10 outputs a voice instruction to the headset of the customer service clerk. Therefore, the customer service clerk can acquire the instruction even while performing other work. In this respect as well, the shop management server 10 achieves improvement in work efficiency of the customer service clerk.

The operation of the customer service clerk after the output of the instruction from the shop management server 10 may be determined at each shop. For example, at each shop, rules may be determined such that a customer service clerk who is available or a customer service clerk close to the serving space serves the dish.

The determination model storage unit 110 may store a determination model for determining an available customer service clerk from the image of the dining space. Hereinafter, this determination model will be called “availability determination model”. In this case, the shop management server 10 may operate as described below, for example. When the instruction acquisition unit 150 acquires an instruction, the instruction acquisition unit 150 or the instruction output unit 160 acquires an available customer service clerk using the availability determination model. The instruction output unit 160 outputs the serving instruction to the headset of the available customer service clerk. Also in the following detailed examples, the shop management server 10 may output an instruction to an available customer service clerk using the above “availability determination model”.

(2) Replenishment of Drinking Water

Operations of the shop management server 10 in replenishing a cup placed on the table with drinking water for a customer will be described. In the following description, the shop management server 10 uses an image of the table on which the cup is placed as the image of the shop. It is assumed that an identifier mark for identifying each table is attached to the surface of the table. The image of the table may be an image of a single table or an image of a plurality of tables.

The instruction determination unit 140 uses a determination model for determining the necessity of an instruction to replenish drinking water. Hereinafter, this determination model will be called “water replenishment determination model”. For example, the instruction determination unit 140 applies the image of the cup on the table to the water replenishment determination model to determine the necessity of the instruction to replenish drinking water. For example, if there is an empty cup, the instruction determination unit 140 may determine that an instruction to replenish drinking water is necessary. Alternatively, if there is a cup containing less drinking water than a threshold such as a half amount of the cup, the instruction determination unit 140 may determine that an instruction to replenish drinking water is necessary. The instruction determination unit 140 may determine the identifier of the table on which the cup determined to require replenishment is placed.

Next, operations of the shop management server 10 will be described. The image acquisition unit 130 acquires an image of a table. The instruction determination unit 140 applies the image of the table to the water replenishment determination model to determine whether an instruction to replenish drinking water is necessary. If the instruction is unnecessary, the shop management server 10 returns to the image acquisition operation by the image acquisition unit 130. If the instruction is necessary, the instruction determination unit 140 determines the type of the instruction to replenish drinking water as the type of the necessary instruction. The instruction acquisition unit 150 acquires the instruction to replenish drinking water stored in the instruction storage unit 120. The instruction output unit 160 outputs the instruction to the headset of the customer service clerk. The instruction acquisition unit 150 may generate an instruction to the customer service clerk using the acquired instruction to replenish drinking water and the identifier of the table on which the cup determined to require replenishment is placed. The instruction in this case is an instruction such as “Replenish drinking water at table B”, for example.

In this manner, when it is necessary to replenish drinking water, the shop management server 10 outputs an instruction to replenish drinking water to the customer service clerk. Therefore, the customer service clerk does not need to check the remaining amount of drinking water in the cup. That is, the shop management server 10 reduces the work burden on the customer service clerk, and achieves improvement in work efficiency. The shop management server 10 may output an instruction to replenish a drink different from drinking water, such as coffee. The shop management server 10 may output an instruction to replenish food, such as a refill of rice at a shop where refills of rice are free.

(3) Support of Customer Service Clerk

Operations of the shop management server 10 for a customer service clerk to support another customer service clerk will be described. In the following description, the shop management server 10 uses an image of a dining space as the image of the shop.

The instruction determination unit 140 uses a determination model for determining the necessity of an instruction to support a customer service clerk. Hereinafter, this determination model will be called “support determination model”. The instruction determination unit 140 determines the necessity of an instruction to support any of the customer service clerks based on the image of the dining space. For example, the instruction determination unit 140 determines the presence or absence of a fallen object such as food or dishware that has fallen during serving or removing dishes, using the image of the dining space. If there is a fallen object, the instruction determination unit 140 determines the necessity of support for disposing of the fallen object, based on the position and state of the fallen object. The state of the fallen object includes the scattering state of the fallen object and the degree of risk of the fallen object such as broken pieces of dishware, for example. The instruction determination unit 140 may determine the necessary of a tool for disposing of the fallen object, such as a cleaning tool, based on the state of the fallen object.

Next, operations of the shop management server 10 will be described. The image acquisition unit 130 acquires an image of a dining space. The instruction determination unit 140 applies the image of the dining space to the support determination model to determine the necessity of an instruction to support the customer service clerk. If the support for the customer service clerk is unnecessary, the shop management server 10 returns to the image acquisition operation by the image acquisition unit 130. If the support is necessary, the instruction determination unit 140 determines the type of support instruction as the type of necessary instruction. The instruction acquisition unit 150 acquires the support instruction stored in the instruction storage unit 120. The instruction output unit 160 outputs the support instruction to the headset of the customer service clerk. The instruction acquisition unit 150 may generate a support instruction based on the type of the support instruction, the position of the fallen object, and a tool necessary for disposal. The instruction in this case is an instruction such as “Food has fallen around table C. Help clean with a cleaning tool”, for example.

In this manner, if the support for a customer service clerk is necessary, the shop management server 10 outputs the support instruction to the customer service clerk without intervention of the customer service clerk. Therefore, the customer service clerk does not need to request support. On the other hand, other customer service clerks do not need to check the state of the customer service clerk who needs support. That is, the shop management server 10 reduces the work burden on the customer service clerk, and achieves improvement in work efficiency.

(4) Clearing (Removing)

Operations of the shop management server 10 for a customer service clerk to removing dishes will be described. In the following description, the shop management server 10 uses an image of a dining space as the image of the shop.

The instruction determination unit 140 uses a determination model for determining the necessity of a removing instruction. Hereinafter, this model is referred to as a “removing determination model”. For example, the instruction determination unit 140 determines the table at which the meal has ended, based on the image of the dining space. For example, in the determination using the image of the dining space, the instruction determination unit 140 may determine the table having no dish on all tableware as the table in which the meal has ended. Alternatively, the instruction determination unit 140 may use, as a criterion for determination on the table at which the meal has ended, a temporal determination criterion that none of customers eat for a predetermined time or more, or a positional determination criterion that all the tableware is put away from the front of the customers. Alternatively, the instruction determination unit 140 may use a determination criterion based on the state of customers, such as the table where all the customers have left. Not limited to the above, the instruction determination unit 140 may use a determination criterion in accordance with the shop. If there is a table where the meal has been finished, the instruction determination unit 140 determines that the removing instruction is necessary. The instruction determination unit 140 may determine the identifier of the table at which the meal has ended.

Next, operations of the shop management server 10 will be described. The image acquisition unit 130 acquires an image of a dining space. The instruction determination unit 140 applies the image of the dining space to the removing determination model to determine the necessity of a removing instruction to the customer service clerk. If the removing instruction is unnecessary, the shop management server 10 returns to the image acquisition operation by the image acquisition unit 130. If the removing instruction is necessary, the instruction determination unit 140 determines the type of the removing instruction as the type of the necessary instruction. The instruction acquisition unit 150 acquires the removing instruction stored in the instruction storage unit 120. The instruction output unit 160 then outputs the removing instruction to the headset of the customer service clerk. The instruction acquisition unit 150 may generate the instruction to the customer service clerk based on the type of the removing instruction and the identifier of the table at which the meal has ended. The instruction in this case is an instruction such as “Dining at table D is finished. Remove dishes”, for example.

In this manner, if removing dishes is necessary, the shop management server 10 outputs the removing instruction to the customer service clerk. Therefore, the customer service clerk does not need to check the table or the like in order to determine the necessity of removing dishes at the end of the meal. That is, the shop management server 10 reduces the work burden on the customer service clerk, and achieves improvement in work efficiency.

(5) Guiding of Customer from Waiting Room

Operations of the shop management server 10 in guiding a customer from the waiting room will be described. In the following description, the shop management server 10 uses an image of a dining space as the image of the shop. The following description is based on the assumption that the order of customer groups in the waiting room and the number of persons in each group have been already stored. Identifiers are allocated to the customer groups.

The instruction determination unit 140 uses a determination model for determining necessity of an instruction to guide a customer waiting in a waiting room. Hereinafter, this model will be called “guidance determination model”. For example, the instruction determination unit 140 first determines a vacant table and the capacity of the table based on the image of the dining space. The instruction determination unit 140 then searches for a group of customers of which the number is within the capacity, in the order of the groups of customers in the waiting room. If there is a group of customers of which the number is within the capacity, the instruction determination unit 140 determines that an instruction to guide the customers to the table is necessary. The instruction determination unit 140 may determine the identifier of the table that is the guidance destination. The instruction determination unit 140 may further determine the identifier of the group to be guided. In the determination on the number of people who can sit, the instruction determination unit 140 may determine the number of people who can sit in a plurality of adjacent tables.

Next, operations of the shop management server 10 will be described. The image acquisition unit 130 acquires an image of a dining space. The instruction determination unit 140 applies the image of the dining space to the guidance determination model to determine the necessity of an instruction to guide the customer service clerk. If the instruction is unnecessary, the shop management server 10 returns to the image acquisition operation by the image acquisition unit 130. If the instruction is necessary, the instruction determination unit 140 determines the type of the guidance instruction as the type of the necessary instruction. The instruction acquisition unit 150 acquires the guidance instruction stored in the instruction storage unit 120. The instruction output unit 160 then outputs the guidance instruction to the headset of the customer service clerk. The instruction acquisition unit 150 may generate an instruction to the customer service clerk using the acquired instruction of the guidance, the identifier of the customer group, and the identifier of the table. The instruction in this case is an instruction such as “Guide the customers in group F to table E”, for example. The shop management server 10 may output not only an instruction to guide customers at the waiting room but also an instruction to guide customers in moving through the shop, such as a change of the table.

In this manner, the shop management server 10 outputs an instruction to guide customers to a vacant table. Therefore, the customer service clerk does not need to determine the availability of the tables and the customers to be guided. That is, the shop management server 10 reduces the work burden on the customer service clerk, and achieves improvement in work efficiency.

(6) Accounting Handling

Operations of the shop management server 10 at the time of accounting will be described. In the following description, the shop management server 10 uses an image of an accounting area as the image of the shop. The accounting process is executed by a customer service clerk, and thus the description thereof will be omitted.

The instruction determination unit 140 uses a determination model that determines necessity of an instruction to a customer service clerk that treats a customer who desires accounting. Hereinafter, this model will be called “accounting determination model”. The instruction determination unit 140 determines whether there is a customer who desires accounting in the accounting area based on the image of the accounting area. However, customers other than customers who desire accounting may come and go to the accounting area. Therefore, the instruction determination unit 140 may determine the presence or absence of a customer who desires accounting, based on the behavior of the customer in the accounting area, for example, stopping in the accounting area. If there is a customer who desires accounting, the instruction determination unit 140 determines that an instruction to the customer service clerk is necessary in order to treat the customer who desires accounting.

Next, operations of the shop management server 10 will be described. The image acquisition unit 130 acquires an image of the accounting area. The instruction determination unit 140 applies the image of the accounting area to the accounting determination model to determine the necessity of an instruction to the customer service clerk who handles the accounting. If the instruction is unnecessary, the shop management server 10 returns to the image acquisition operation by the image acquisition unit 130. If the instruction is necessary, the instruction determination unit 140 determines the type of the accounting instruction as the type of the necessary instruction. The instruction acquisition unit 150 acquires the accounting instruction stored in the instruction storage unit 120. The instruction output unit 160 outputs the accounting instruction to the headset of the customer service clerk. The instruction in this case is an instruction such as “Handle with a customer who wishes to pay at the register”, for example.

In this manner, when there is a customer who desires accounting, the shop management server 10 outputs an accounting instruction. Therefore, the customer service clerk does not need to stay in the accounting area, and can perform other work. That is, the shop management server 10 reduces the work burden on the customer service clerk, and achieves improvement in work efficiency.

(7) Work in External Area of Shop Building

The shop management server 10 may process an instruction to a customer service clerk for work not only the dining space and the like in the building of the shop but also in the area outside of the building of the shop such as a parking lot. As an example, operations of the shop management server 10 in outputting an instruction related to a parking lot will be described. In the following description, the shop management server 10 uses an image of the parking lot as the image of the shop.

The instruction determination unit 140 stores a determination model for determining necessity of an instruction of work related to the parking lot. Hereinafter, this model will be called “parking lot determination model”. The instruction determination unit 140 determines the necessity of an instruction related to a parked vehicle based on the image of the parking lot. For example, the instruction determination unit 140 first determines whether any of the following situations related to the vehicle in the parking lot has occurred using the image of the parking lot.
Forgetting to turn off the lamps of the vehicle such as headlight, backlight, blinker, and interior lamp.
Parking at an inappropriate position, including a position outside a parking range, such as a passage, or a position across parking ranges.
Extremely long-time parking for use in shop.
An accident in the parking lot, such as a minor collision.

Then, if determining that there has occurred any of the above situations, the instruction determination unit 140 determines that an instruction to the customer service clerk is necessary. An example of determination by the instruction determination unit 140 will be described. The instruction determination unit 140 may determine the vehicle number, the vehicle type, and the like in order to distinguish the vehicle in the instruction determination. The instruction determination unit 140 may determine the position of the vehicle as an instruction target using layout information of the parking lot.

Parking at Inappropriate Position

The instruction determination unit 140 determines whether there is a vehicle parked at an inappropriate position based on the layout information and the image of the parking lot. For example, the instruction determination unit 140 may determine a vehicle parked in a passage. Alternatively, the instruction determination unit 140 may determine a vehicle parked across a white line indicating a parking position. If there is a vehicle parked at an inappropriate position, the instruction determination unit 140 determines that an instruction is necessary.

Parking Lot Only for the Handicapped

The instruction determination unit 140 may determine an inappropriate vehicle parked in a parking lot only for the handicapped. For example, the instruction determination unit 140 determines whether a vehicle is parked in the parking lot only for the handicapped, based on the parking lot layout information including the layout of the parking lot only for the handicapped and the image of the parking lot. If there is a parked vehicle, the instruction determination unit 140 determines whether the parked vehicle is a vehicle for the handicapped. For example, as a determination on whether the vehicle is a vehicle for the handicapped, the instruction determination unit 140 may determine whether a handicapped sign is affixed to the vehicle. Alternatively, the instruction determination unit 140 may determine whether the parked vehicle is of a vehicle type for the handicapped or whether a customer who has got off the vehicle is using a wheelchair. If the vehicle parked in the parking lot only for the handicapped is not a vehicle for the handicapped, the instruction determination unit 140 determines that an instruction is necessary.

Long-time Parking

When a vehicle is parked in the parking lot, the instruction determination unit 140 stores the vehicle number and the parking start time in association with each other. The instruction determination unit 140 may use, as the parking start time, the time at which the vehicle enters the parking lot or the time at which the customer who has got off the vehicle locks the vehicle, for example. The instruction determination unit 140 may determine long-time parking based on the elapsed time from the parking start time. Alternatively, upon detecting entry of a vehicle into the parking lot, the instruction determination unit 140 generates a parking time measurement timer in association with the vehicle. For example, the instruction determination unit 140 associates the vehicle number with the parking time measurement timer. The instruction determination unit 140 starts counting by the generated parking time measurement timer. The instruction determination unit 140 may determine that the vehicle associated with the parking time measurement timer whose count value exceeds a threshold is a vehicle parked for a long time. If there is a vehicle parked for a long time, the instruction determination unit 140 determines that an instruction is necessary.

Next, operations of the shop management server 10 will be described. The image acquisition unit 130 acquires an image of the parking lot. The instruction determination unit 140 applies the image of the parking lot to a parking lot determination model to determine the necessity of an instruction to the customer service clerk. If the instruction is unnecessary, the shop management server 10 returns to the image acquisition operation by the image acquisition unit 130. If the instruction is necessary, the instruction determination unit 140 determines the type of the vehicle instruction as the type of the necessary instruction. The instruction acquisition unit 150 acquires the instruction related to the vehicle stored in the instruction storage unit 120. The instruction output unit 160 outputs the instruction to the headset of the customer service clerk. The instruction in this case is any of the following instructions, for example.
The instruction in the case of forgetting to turn off the lamp is an instruction such as “The lamp of the vehicle with vehicle number G is not turned off. Notify the customer that the lamp is not turned off”.
The instruction in the case of inappropriate parking is an instruction such as “The vehicle with vehicle number H is not parked at the correct location. Ask the customer to change the parking location”.
The instruction in the case of long-time parking is an instruction such as “The vehicle with vehicle number I has been parked for a long time. Check with the customer about the parked vehicle. If there is no customer of the vehicle, contact the police”.
The instruction in the case of an accident is an instruction such as “There is a possibility that the vehicle with vehicle number J has caused an accident in the parking lot. Check the situation and contact the police as necessary”.

In this manner, the shop management server 10 outputs an instruction related to the vehicle parked in the parking lot. Therefore, the customer service clerk does not need to check the state of the vehicle in the parking lot, and can perform other work. That is, the shop management server 10 reduces the work burden on the customer service clerk, and achieves improvement in work efficiency. The shop management server 10 may store the vehicle number and image of the vehicle having caused an accident, the vehicle number and image of the vehicle parked at an inappropriate position, or the vehicle number and image of the vehicle parked for a long time.

(8) Work for Sudden or Exceptional Events

In the above description, the shop management server 10 outputs instructions for normal work at a restaurant. However, the shop management server 10 may output work instructions in response to a sudden or exceptional events such as a fire. Hereinafter, as examples of sudden or exceptional events, a quarrel between customers, a fire, and a crime will be described. In the following description, the shop management server 10 uses an image of the dining space, an image of the waiting room, an image of the accounting area, an image of the entrance, and an image of the parking lot as the image of the shop. Hereinafter, these images will be collectively called “exceptional event area image”. In the case of handling a sudden or exceptional event, the shop management server 10 may use, as the exceptional event area image, images of areas that are not used by the customer service clerk for customer service, such as the kitchen, the shop office, the entrance of employees, and the garbage dump, in addition to the above images.

The instruction determination unit 140 uses a determination model for determining necessity of an instruction for each of a quarrel, a fire, and a crime. Hereinafter, models for a quarrel, a fire, and a crime will be called “quarrel determination model”, “fire determination model”, and “crime determination model”, respectively. Models for sudden or exceptional events such as “quarrel determination model”, “fire determination model”, and “crime determination model” will be collectively called “exceptional process determination model”.

The instruction determination unit 140 applies an image of an exceptional event area to the quarrel determination model to determine whether a quarrel has occurred between customers. The instruction determination unit 140 may determine the occurrence of a quarrel between a shop clerk and a customer and the occurrence of a quarrel between shop clerks. If a quarrel has occurred, the instruction determination unit 140 determines that an instruction is necessary. The instruction determination unit 140 applies an image of an exceptional event area to the fire determination model to determine whether a fire has occurred. If a fire has occurred, the instruction determination unit 140 determines that an instruction is necessary.

The instruction determination unit 140 applies an image of an exceptional event area to the crime determination model to determine whether a crime has occurred. As the presence or absence of the occurrence of a crime, the instruction determination unit 140 may determine the presence or absence of a criminal holding a weapon such as a knife based on the image of the exceptional event area, for example. The instruction determination unit 140 may determine, based on the image of the accounting area, the occurrence of bilking a bill by determining whether a customer who has not completed the payment has gone out of the shop. The instruction determination unit 140 may determine the occurrence of luggage lifting based on the action of a customer in the image of the dining space. The instruction determination unit 140 may determine the occurrence of child abduction. In this case, for example, the instruction determination unit 140 checks a person who has taken a child out of the shop determined based on the images of the dining area and the accounting area against a customer related to the child determined based on the information of a customer group, thereby to determine whether the person who has taken the child out of the shop is an appropriate person. If the person who has taken out the child is an inappropriate person, the instruction determination unit 140 may determine that child abduction has occurred. The instruction determination unit 140 may determine the presence or absence of an illegal action on a vehicle in the parking lot, such as tampering with the door of the vehicle by an unrelated person, based on information on the vehicle in the parking lot and the customer associated in advance with the vehicle. If a crime has occurred, the instruction determination unit 140 determines that an instruction is necessary.

In addition to the above determinations, the instruction determination unit 140 may determine the place of occurrence of an event, the presence or absence of an injured person, and the like. For example, the instruction determination unit 140 may determine the place of occurrence of an event using the layout information.

If a fire or the like occurs at a place where a shop clerk such as a customer service clerk is present, the clerk can immediately become aware of the occurrence of the fire or the like. On the other hand, the occurrence of a fire or the like in a place that is not frequently visited by a shop clerk may be detected late. Therefore, the shop management server 10 may operate using, as the image of the exceptional event area, an image of a place where a shop clerk such as a customer service clerk rarely enters. The shop management server 10 may set the frequency of determination on the place that the shop clerk less frequently enters in such a way as to be higher than the frequency of determination on the place that the shop clerk frequently enters. The shop management server 10 may use, as an exceptional process determination model used for determination on the place that the shop clerk less frequently enters, a model higher in accuracy than an exceptional process determination model used for determination on the place that the shop clerk frequently enters.

Next, operations of the shop management server 10 will be described. The image acquisition unit 130 acquires an image of an exceptional event area. The instruction determination unit 140 applies the image of the exceptional event area to the exceptional process determination model to determine whether an instruction to the customer service clerk is necessary. If the instruction is unnecessary, the shop management server 10 returns to the image acquisition operation by the image acquisition unit 130. If the instruction is necessary, the instruction determination unit 140 determines the type of the sudden or exceptional event instruction as the type of the necessary instruction. The instruction acquisition unit 150 acquires the instruction stored in the instruction storage unit 120. The instruction output unit 160 outputs the instruction to the headset of the customer service clerk. The instruction in this case is any of the following instructions, for example. In the case of a crime or a fire, the instruction output unit 160 may report the occurrence of the crime or the fire to the police station or the fire department without going through the customer service clerk.
The instruction in the case of a quarrel is an instruction such as “Argument has occurred near K. Head to arbitration immediately”.
The instruction in the case of a fire is an instruction such as “A fire has occurred near L. Check the situation immediately, and perform first-aid fire-fighting and evacuation guidance for customers, and contact the fire department”.
The instruction in the case of a crime is an instruction such as “A crime has occurred near M. Check the situation and contact the police immediately”.

In this manner, if a sudden or exceptional event occurs, the shop management server 10 outputs an instruction for responding to that. For example, the shop management server 10 determines an event in a place where a customer service clerk does not enter and outputs an instruction according to the determination. Therefore, the customer service clerk does not need to check such a place, and can perform other work. That is, the shop management server 10 reduces the work burden on the customer service clerk, and achieves improvement in work efficiency.

As described above, the shop management server 10 stores the determination model for determining the necessity of the instruction to the customer service clerk at the shop, based on the image of the shop where products are provided to customers. The shop management server 10 further stores an instruction to the customer service clerk at the shop. Upon acquiring the image of the shop, the shop management server 10 applies the image of the shop to the determination model to determine the type of instruction to the customer service clerk. The shop management server 10 acquires the instruction of the determined type and outputs the acquired instruction to the customer service clerk. By executing such operations, the shop management server 10 can reduce the work burden on the customer service clerk and improve work efficiency.

[Variations]

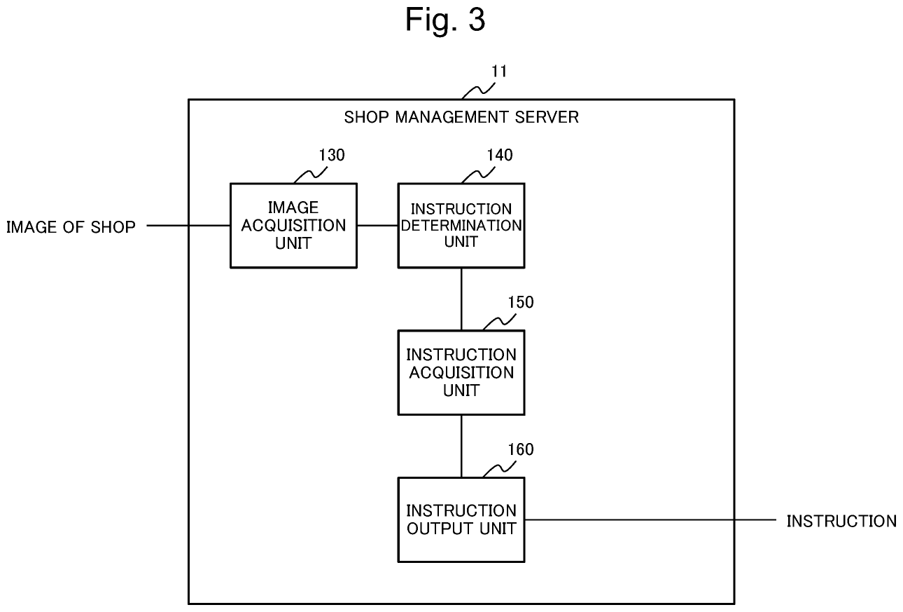

The shop management server 10 may use an external storage device as the determination model storage unit 110 and the instruction storage unit 120. FIG. 3 is a block diagram illustrating an example of a configuration of a shop management server 11 which is another configuration of the shop management server 10. The shop management server 11 includes an image acquisition unit 130, an instruction determination unit 140, an instruction acquisition unit 150, and an instruction output unit 160. At a shop where customers consume products, the image acquisition unit 130 acquires an image of the shop that shows at least one of an area for providing the products to the customers and an area in which the customers consume the products. The instruction determination unit 140 applies the image of the shop to a determination model for determining an instruction, and determines the type of instruction to a customer service clerk who provides a product to a customer. For example, the instruction determination unit 140 determines the type of the instruction by applying the image of the shop to the determination model stored in the storage device corresponding to the determination model storage unit 110. The instruction acquisition unit 150 acquires an instruction corresponding to the determined type of instruction. For example, the instruction acquisition unit 150 acquires an instruction stored in a storage device corresponding to the instruction storage unit 120. The instruction output unit 160 outputs the acquired instruction to the customer service clerk. In this manner, each component of the shop management server 11 operates similarly to the corresponding component of the shop management server 10, and implements the same function.

[Hardware Configuration]

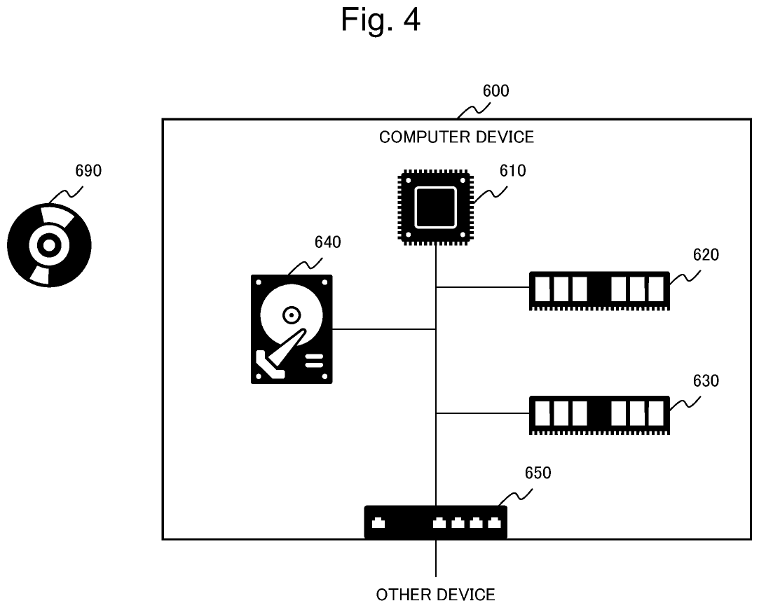

Next, a hardware configuration of the shop management servers 10 and 11 will be described using the shop management server 10. Each component of the shop management server 10 may be configured by a hardware circuit. Alternatively, each component of the shop management server 10 may be configured using a plurality of devices connected via a network. For example, the shop management server 10 may be configured using cloud computing. Alternatively, the plurality of components of the shop management server 10 may be configured by one piece of hardware. Alternatively, the shop management server 10 may be implemented as a computer device that includes a central processing unit (CPU), a read only memory (ROM), a random access memory (RAM), and a network interface card (NIC). FIG. 4 is a block diagram illustrating a configuration of a computer device 600 that is an example of a hardware configuration of the shop management server 10. The computer device 600 includes a CPU 610, a ROM 620, a RAM 630, a storage device 640, and an NIC 650.

The CPU 610 reads a program from at least one of the ROM 620 and the storage device 640. The CPU 610 controls the RAM 630, the storage device 640, and the NIC 650 based on the read program. The computer device 600 including the CPU 610 controls these components to function as the image acquisition unit 130, the instruction determination unit 140, the instruction acquisition unit 150, and the instruction output unit 160. In this manner, the shop management server 10 may implement the functions as a combination of hardware and software.

The CPU 610 may also read a program included in the recording medium 690 storing the program in a computer-readable manner, using a recording medium reading device (not illustrated). Alternatively, the CPU 610 may receive a program from an external device (not illustrated) via the NIC 650, store the program in the RAM 630 or the storage device 640, and operate based on the stored program.

The ROM 620 stores programs to be executed by the CPU 610 and fixed data. The ROM 620 is a programmable ROM (P-ROM) or a flash ROM, for example. The RAM 630 temporarily stores programs to be executed by the CPU 610 and data. The RAM 630 is a dynamic RAM (D-RAM), for example. The storage device 640 stores data and programs to be stored for a long time in the computer device 600. The storage device 640 implements functions as the determination model storage unit 110 and the instruction storage unit 120. The storage device 640 may operate as a temporary storage device of the CPU 610. The storage device 640 is a hard disk device, a magneto-optical disk device, a solid state drive (SSD), or a disk array device, for example.

The ROM 620 and the storage device 640 are non-transitory recording media. On the other hand, the RAM 630 is a transitory recording medium. The CPU 610 is operable based on programs stored in the ROM 620, the storage device 640, and the RAM 630. That is, the CPU 610 is operable using either a non-transitory recording medium or a transitory recording medium. When implementing each function, the CPU 610 may use at least one of the RAM 630 and the storage device 640 as a temporary storage medium of programs and data.

The NIC 650 relays exchange of data with an external device (not illustrated) via a network. The NIC 650 implements at least some of the functions of the image acquisition unit 130 and the instruction output unit 160. The NIC 650 is a wireless LAN card or a LAN hub, for example. The NIC 650 may be used in either a wired or wireless manner. For example, the NIC 650 relays communication with the camera in the shop and the headset of the customer service clerk.

The computer device 600 configured in this manner executes the operations of the components of the shop management server 10 to function as the shop management server 10.

One of the purposes of processing shop information is to improve work efficiency of customer service clerks who provide food and the like to customers. The technique described in JP 2019-192056 A is a technique for managing contents of services for members. The technique described in JP 2015-210601 A is a technique for outputting a notification to a customer via a customer terminal operated by the customer. The technique described in JP 2003 044954 A is a technique for determining a crime. As described above, the techniques described in JP 2019-192056 A, JP 2015-210601 A, and JP 2003-044954 A are not intended to improve the work efficiency of customer service clerks.

An example advantage according to the invention is the improvement of work efficiency of customer service clerks.

Although the present invention has been described with reference to the example embodiments, the present invention is not limited to the above example embodiments. Various modifications that can be understood by those skilled in the art can be made to the configuration and details of the present invention within the scope of the present invention.

1. A shop management server comprising:
a memory; and
at least one processor coupled to the memory,
the processor performing operations, the operations comprising:
acquiring, at a shop in which a customer consumes a product, an image of the shop that is an image showing at least one of an area for providing the product to the customer and an area in which the customer consumes the product;
determining a type of an instruction to a customer service clerk who provides the product to the customer by applying the image of the shop to a determination model for determining the instruction;
acquiring the instruction corresponding to the determined type of the instruction; and
outputting the acquired instruction to the customer service clerk.

2. The shop management server according to claim 1, wherein
the type of the instruction includes at least one of serving a dish, replenishment of drinking water, support of the customer service clerk, removing a dish, guidance of the customer from a waiting room, accounting, work in an area outside a building of the shop, and work at occurrence of a sudden or exceptional event.

3. The shop management server according to claim 1, wherein the operations further comprise:
outputting voice information to the customer service clerk as the instruction.

4. The shop management server according to claim 1, wherein the operations further comprise:
determining the customer service clerk who is available using the image of the shop, and
outputting the instruction to the available customer service clerk.

5. A non-transitory, computer-readable recording medium that records a program for causing a computer to perform a method, the method comprising:
acquiring, at a shop in which a customer consumes a product, an image of the shop that is an image showing at least one of an area for providing the product to the customer and an area in which the customer consumes the product;
determining a type of an instruction to a customer service clerk who provides the product to the customer by applying the image of the shop to a determination model for determining the instruction;
acquiring the instruction corresponding to the determined type of the instruction; and
outputting the acquired instruction to the customer service clerk.

6. A non-transitory, computer-readable recording medium that records the program according to claim 5, wherein
the type of the instruction includes at least one of serving a dish, replenishment of drinking water, support of the customer service clerk, removing a dish, guidance of the customer from a waiting room, accounting, work in an area outside a building of the shop, and work at occurrence of a sudden or exceptional event.

7. A non-transitory, computer-readable recording medium that records the program according to claim 5, wherein
the outputting includes outputting voice information as the instruction.

8. A non-transitory, computer-readable recording medium that records the program according to claim 5 for causing a computer to perform the method further comprising:
determining the customer service clerk who is available using the image of the shop, wherein
the outputting includes outputting the instruction to the available customer service clerk.

9. A shop management method comprising:
acquiring, at a shop in which a customer consumes a product, an image of the shop that is an image showing at least one of an area for providing the product to the customer and an area in which the customer consumes the product;
determining a type of an instruction to a customer service clerk who provides the product to the customer by applying the image of the shop to a determination model for determining the instruction;
acquiring the instruction corresponding to the determined type of the instruction; and
outputting the acquired instruction to the customer service clerk.

10. The shop management method according to claim 9, wherein
the type of the instruction includes at least one of serving a dish, replenishment of drinking water, support of the customer service clerk, removing a dish, guidance of the customer from a waiting room, accounting, work in an area outside a building of the shop, and work at occurrence of a sudden or exceptional event.
